(19) United States
(12) Patent Application Publication
(10) Pub. No.: US 2009/0196572 A1
(43) Pub. Date: Aug. 6, 2009

(54) Rewind Playback of Media

(75) Inventors: David Burg, Bellevue, WA (US); Vladimir Sadovsky, Redmond, WA (US)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 12/025,536

(22) Filed: Feb. 4, 2008

(51) Int. Cl. H04N 5/91

(52) U.S. Cl. 386/68

(57) ABSTRACT

Systems and methods of media optimization are disclosed herein. An operation command can be sent to a media device from a host device. The operation command can be indicative of an intent to perform an operation on the recording medium. A list of media device characteristics corresponding to media device resources can be received from the media device. One or more selections of values of the media device characteristics can be sent from the host device to the media device in order to optimize the operation command. A response can be received from the media device of performance of the operation command.

### BACKGROUND

Modern media rendering devices have become popular in today's world and have allowed the ubiquitous proliferation of digital content. As part of viewing video content, users like to view the content in reverse. In other words, users request a rewind playback of the video at various speeds. Conventional media devices read spinning media, such as optical discs, in one direction. Therefore, rewind playback of the media requires continuous backward skipping.

### SUMMARY

The following presents a simplified summary of the disclosure in order to provide a basic understanding to the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

Described herein are various techniques and technologies directed to communication of the high-level host device intentions to the media device. Various techniques of optimization of the media device internal operations based on the communicated high-level host intentions are also disclosed herein.

Many of the attendant features will be more readily appreciated as the same becomes better understood by reference to the following detailed description considered in connection with the accompanying drawings.

### DESCRIPTION OF THE DRAWINGS

The present description will be better understood from the following detailed description read in light of the accompanying drawings, wherein:

FIG. 1 illustrates a diagram of a system for rewind playback according to one embodiment.

FIG. 2 illustrates a diagram of a spiral data track of a recording medium according to one embodiment.

FIG. 3 illustrates a data flow diagram of a process of providing rewind playback according to one embodiment.

FIG. 4 illustrates a data flow diagram of a process of providing rewind playback according to another embodiment.

FIG. 5 illustrates a component diagram of a computing device for implementing one or more embodiments.

Like reference numerals are used to designate like parts in the accompanying drawings.

### DETAILED DESCRIPTION

The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

The system described is provided as an example and not a limitation. As those skilled in the art will appreciate, the present examples are suitable for application in a variety of different types of synchronization of postings.

Described herein are various techniques and technologies directed to a mechanism for optimized operations of content in a recording medium. The recording medium can be an optical disc, or any other type of recording medium now known or to become known. Optimized operations can include error correction, compression, rewind playback, and others. Operation of media content on optical discs, such a CD or DVD, requires special attention when accessing the spinning disc.

In conventional systems, the media device, such as a CD-ROM drive or DVD player, is only able to read the recording medium using a spiral movement on the media in one direction. The one direction is generally forward. Thus, to address the host device's request of reading the media backwards, the media device reads a contiguous incremental sequence of blocks, seek to the previous contiguous incremental sequence of blocks, read them, and seek again. The length of the contiguous incremental sequence of blocks is decided by the host device. However the host device is not aware of the physical properties of the media device such as media device data buffer size, revolutions per minute, seek time, data blocks per revolution, landing position of the head after a seek, and the like. Thus the read length decided by the host device is generally not optimal. As a result, the rewind playback and other operations suffer from jitter.

The systems and methods disclosed herein permit a smooth operation of the recording medium. In order to achieve this, the host device can be configured to communicate an intent to the media device of an operation to be performed. As used herein, an intent can include an expression of interest by the host device to request the performance of an operation at the host device. For instance, such operation can include localized compression of data, error correction, rewind playback, and others.

In the example of rewind playback, the media device can be configured to start reading before the requested address of a given data block. The media device can further be configured to buffer data that is not part of the requested data block, but that can be used later as part of another rewind request.

In another embodiment, the host device software and the media device can be configured to collaborate in such a way that the read lengths are optimal for the rewind speed selected by the user. Instead of the host device issuing burst of contiguous blocks read to the media device, the host device can be configured to select a rewind speed from a list of supported rewind speeds reported by the media device, set a start block address for the rewind read, and read decrementing address. As long as the host device is reading contiguously decrementing block aligned addresses, the media device can ensure to deliver data at the agreed rewind speed. If the host device issues a read command at a non-contiguous address, a seek delay is expected and permitted.

The media device can be configured to build a list of supported rewind speeds based advanced knowledge of its physical properties, and the physical properties of the media. In particular, the maximum rewind speed can use optimal timing for the time consuming seek between two burst of contiguous incremental read of sequence of blocks. Or, the media device may implement the physical capability to rotate the disc backward and rewind read the spiral physically.

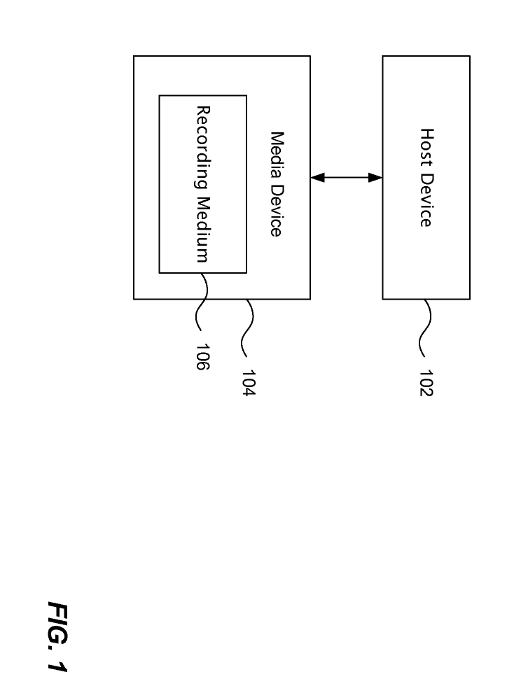

FIG. 1 illustrates a diagram of a system for rewind playback according to one embodiment. For example, the system can include a host device 102, and a media device 104 that accesses a recording medium 106.

The host device 102 can be configured to provide a user interface as well as to communicate with the media device 104 in order to send and receive media data. For instance, the host device 102 can be a personal computer, and the media device 104 can be a DVD player. Many other examples of a host device are contemplated, such as laptop computers, Smartphones, PDAs, and the like.

Thus, the host device 102 can be configured to send to the media device 104 a rewind playback command. Therefore, the rewind playback command can be an initial expression of intention of the host device 102 to carry out a rewind playback.

The host device 102 can be configured with one or more APIs that can be used by applications. For example, the host device 102 can be configured with video playback APIs for rewind playback, playback direction to rewind, select, increment or decrement speed of rewind, cache non-requested read data, and so on. A stop rewind read command can also be defined to resume normal incremental access. In a further embodiment, the host device 102 can be configured to play back the multiple data blocks received from the media device 104.

The host device 102 can further be configured with an application that can open a media device session and request information about storage device supported intents. Based on application interpretation of user needs, the host device 102 can explicitly communicate intent to the media device, which informs the media device how to interpret following data. Additionally, the host device 102 can be configured to organize, or request a local application to organize, the data stream according to earlier reported media device properties.

In another embodiment, the host device 102 can be configured to monitor user action patterns. The host device 102 can choose the type of monitoring based on the intents supported by the media device 104. For instance, if the media device 104 can optimize writes for bandwidth, user actions can be monitored to timing since the user prefers faster operation rather than power savings.

The media device 104 can be configured with data indicative of physical characteristics of the media device 104 and the recording medium. The firmware within the media device 104 can be configured to translate the data into an array of generalized properties, which can be reported to the host device 102 during media device 102 initialization. Such properties provided by the media device can include a table of playback speeds, optimal size of input/output operation, alignment properties, and others.

Therefore, there can be a set of general intents (such as optimization targets) which are well defined between host device 102 and the target device 104. Examples of such intents can include “maximize speed of write,” “optimize power consumption,” “optimize for reliable placement,” “optimize for rewind playback,” and the like. In one example, when the media device 104 is being initialized, the firmware in the media device reports a list of intents to the host device 104 for input/output operations.

In one embodiment, the media device 104 can be configured to receive a rewind playback command indicative of a rewind playback intent. The media device 104 can then prepare for the rewind playback. For instance, as part of preparing for the rewind, the media device 104 can be configured to provide the playback speeds available to the media device 104 depending on its resources and the type of media to be played. In another example, the media device 104 can be configured to start caching read data that has not been yet requested by the host device 102.

Upon receiving the rewind playback command from the host device 102, the media device 104 can configure various parameters and prepare for the playback. For instance, the media device 104 can send a list of speeds to the host device 102. In one example, the media device 104 can determine optimal data block sizes to send to the host device 102. In another example, the media device 104 receives optimal data block sizes and memory pointer from the host device 102.

The media device 104 can also read one or more data blocks. For example, the media device 104 can read a first data block from the recording medium, and send the first data block to the host device. The media device 104 can also be configured to start reading at a location in the recording medium having a location address that is less than a second data block starting address of a second data block. The second data block starting address can be less than the first data block starting address of the first data block.

Furthermore, the media device 104 can also be configured to read additional data from the recording medium. Such additional data can be read starting at the location address and continuing to the second data block starting address. In conventional systems, this data is ignored until the second data block starting address is reached. However, the media device 104 can be configured to read such additional data and store the data for future use. For instance, the media device 104 can access the stored additional data if subsequent commands to continue to perform rewind playback is received. In another embodiment, once the media device 104 receives a rewind playback command from the host device 102 the media device 104 can continuously cache the media data being read assuming that all the data being read may be used as part of the rewind playback.

Thus, in one example, the media device 104 can be configured to store additional data read from the recording in temporary memory. In another example, the media device 104 can be configured to send the temporary data to the host device upon receiving a subsequent read command to read at least a portion of the additional data.

In another example, the media device 104 can be configured to send a list of rewind playback speeds to the host device 102. The media device 104 can receive the playback rewind speed from the host device 102. The playback rewind speed can be a selection of speed from the list of rewind playback speeds.

In another embodiment, the media device 104 and the host device 102 can send back and forth a sequence of commands in order to prepare for the rewind playback, and during the rewind playback. For instance, one such sequence of commands can be the following sequence. The host device sends a rewind playback command to the media device 104. The media device 104 sends a list of rewind speeds with matching optimized read length to the host device 102. The host device 102 sends a selection of the speeds selected. The media device 102 reading data from a medium with the selected optimal length and selected speed. The host device 102 sends a stop command to resume forward playback to the media device.

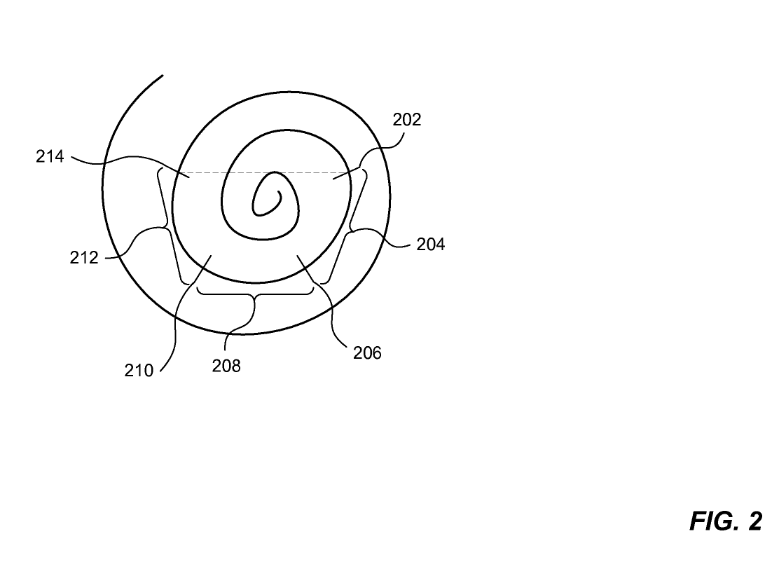

FIG. 2 illustrates a diagram of a spiral data track of a recording medium according to one embodiment. As previously mentioned, the host device 102 can send to the media device a rewind playback command. In one example, the rewind playback command can include instructions to rewind playback starting at location 214. Therefore, the rewind playback command can request that at least two data blocks, namely data block 212 and data block 208, be read. In order to accomplish this, the media device 104 can be configured to read a first data block 212 starting at the first data block address 210. Once this data block is read, the next data block to be read is a second data block 208 starting at a second data block address 206. Because data is read in one direction, once the reading head of the spinning media finishes reading data block 212, the head has to start reading at the second data block address 206 or earlier in the spiral data track. To do this, the media device 104 can move the head to location 202. Note that in conventional media devices 104, the head moves in a straight line and therefore the head would move straight from location 214 to location 202. At this point, the head of the media device 104 can start reading the data as the recording medium spins. Note that the data in data block 204 does not need to be read because the host device 102 did not request these data in the previous example. Therefore, the data in data block 204 is not used. As described above, the data in data block 204 can be cached in anticipation of an eventual request to rewind playback of the data block 204. Furthermore, the location 202 in which the reading head lands varies according to the rotation speed of the recording medium.

In one embodiment, the host device 102 can be configured to send the rewind playback command to the media device 104. In conventional systems the host device generally sends a separate read command for each data block, such as an instruction for reading data block 212, then reading data block 208, then reading data block 204, and so on. On the contrary, the methods disclosed herein permit the host device to signal to the media device using the rewind playback command.

In a further embodiment, the media device can send back to the host device 102 data block by data block. The data within each data block is not inverted in order to preserve data coherency. In order to accomplish this, the host device 102 and the media device 104 may agree on the size of the data block (e.g., ECC block, sector, or other sizes). For instance, the host device software may be using fixed chunk of encoded video and ask the media device to provide this length of data or a multiple of the length of this data at a time. The host device software and target media device may agree to skip chunk of data for a faster rewind.

The media device can supply the host device a list of additional optimal backward playback speeds, which the target media device can have optimized based on the physical characteristics of the media and the media device itself. The host device software can be able to instruct the media device to select any given speed of this list, and can be able to instruct the media device to step one step faster or one speed slower in this list until the playback speed is satisfactory to the user.

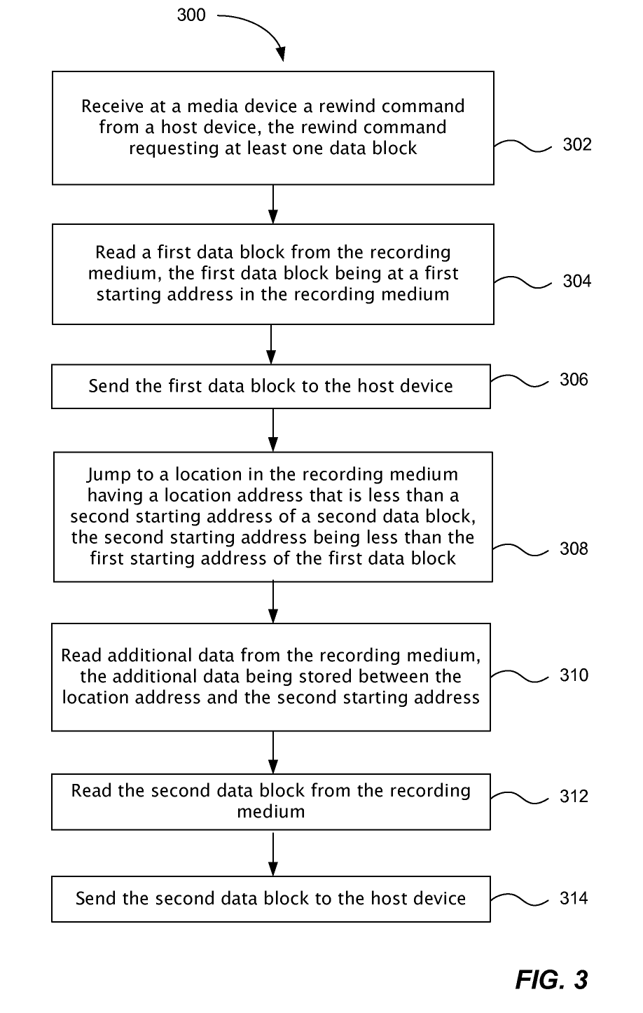

FIG. 3 illustrates a data flow diagram of a process 300 of providing rewind playback. At process block 302, a rewind playback command is received at a media device from a host device, the rewind playback command requesting at least one data block. The process 300 continues at process block 304.

At process block 304, a first data block is read from the recording medium, the first data block being at a first data block starting address in the recording medium. The process 300 continues at process block 306.

At process block 306, the first data block to the host device. The process 300 continues at process block 304. At process block 302, the process permits the media device to jump to a location in the recording medium having a location address that is less than a second data block starting address of a second data block. The second data block starting address being less than the first data block starting address of the first data block. The process 300 continues at process block 308.

At process block 308, additional data from the recording medium is read. The additional data being read starting at the location address to the second data block starting address. The process 300 continues at process block 310.

At process block 310, the second data block is read from the recording medium. The process 300 continues at process block 312. At process block 312, sending the second data block to the host device.

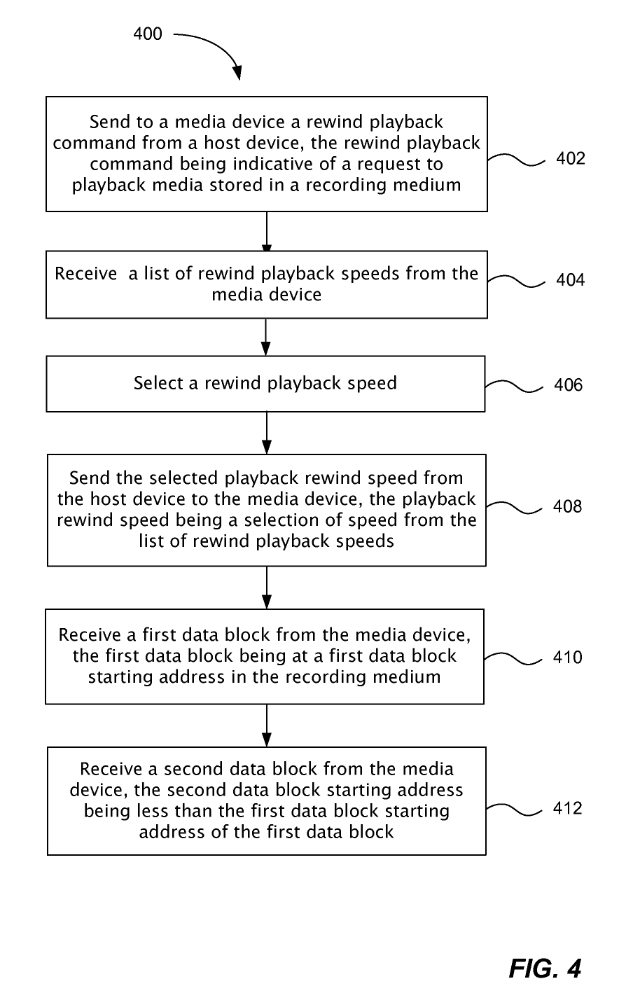

FIG. 4 illustrates a data flow diagram of a process of providing rewind playback according to another embodiment. At process block 402, a rewind playback command is sent from a host device to a media device. The rewind playback command can be indicative of a request to playback media stored in a recording medium in reverse order. The process 400 continues at process block 404. At process block 404, a list of rewind playback speeds is received from the media device. The process 400 continues at process block 406. At process block 406, a rewind playback speed is selected. In one example, the rewind playback speed is selected based on user input received at a media player device. In another example, the rewind playback speed is selected based on the size of the data block. The process 400 continues at process block 408.

At process block 408, the selected playback rewind speed is sent from the host device to the media device. The playback rewind speed can be a selection of speed from the list of rewind playback speeds. The process 400 continues at process block 410.

At process block 410, a first data block is received from the media device. The first data block can be at a first data block starting address in the recording medium. The process 400 continues at process block 412. At process block 412, a second data block is received from the media device. The second data block starting address can be less than the first data block starting address of the first data block.

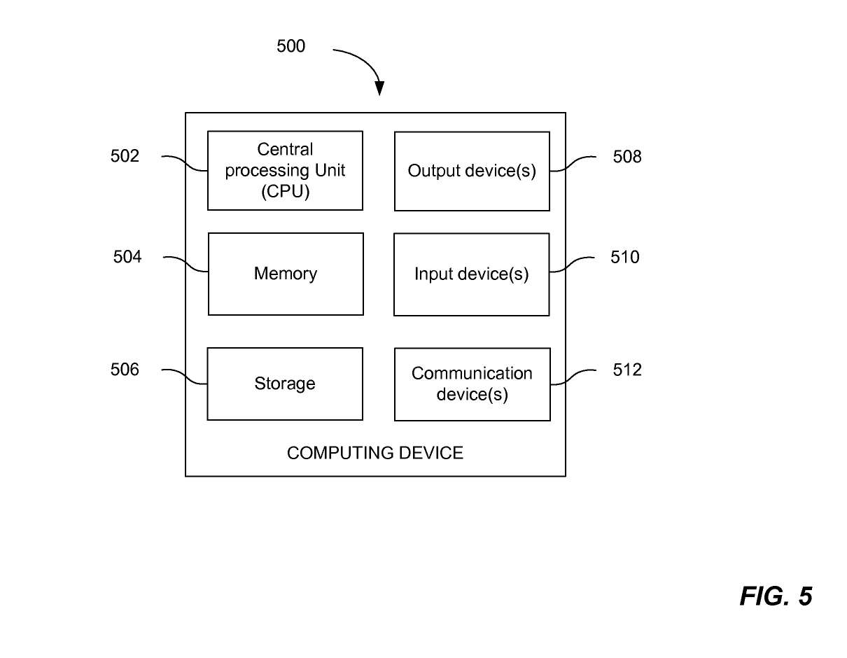

FIG. 5 illustrates a component diagram of a computing device for implementing one or more embodiments. The computing device 500 can be utilized to implement one or more computing devices, computer processes, or software modules described herein. In one example, the computing device 500 can be utilized to process calculations, execute instructions, receive and transmit digital signals. In another example, the computing device 500 can be utilized to process calculations, execute instructions, receive and transmit digital signals, receive and transmit search queries, and hypertext, compile computer code, as required by the host device 102 and the media device 104.

The computing device 500 can be any general or special purpose computer now known or to become known capable of performing the steps and/or performing the functions described herein, either in software, hardware, firmware, or a combination thereof.

In its most basic configuration, computing device 500 typically includes at least one central processing unit (CPU) 502 and memory 504. Depending on the exact configuration and type of computing device, memory 504 may be volatile (such as RAM), non-volatile (such as ROM, flash memory, etc.) or some combination of the two. Additionally, computing device 500 may also have additional features/functionality. For example, computing device 500 may include multiple CPU's. The described methods may be executed in any manner by any processing unit in computing device 500. For example, the described process may be executed by both multiple CPU's in parallel.

Computing device 500 may also include additional storage (removable and/or non-removable) including, but not limited to, magnetic or optical disks or tape. Such additional storage is illustrated in FIG. 5 by storage 206. Computer storage media includes volatile and nonvolatile, removable and non-removable media implemented in any method or technology for storage of information such as computer readable instructions, data structures, program modules or other data. Memory 504 and storage 506 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by computing device 500. Any such computer storage media may be part of computing device 500.

Computing device 500 may also contain communications device(s) 512 that allow the device to communicate with other devices. Communications device(s) 512 is an example of communication media. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The term computer-readable media as used herein includes both computer storage media and communication media. The described methods may be encoded in any computer-readable media in any form, such as data, computer-executable instructions, and the like.

Computing device 500 may also have input device(s) 510 such as keyboard, mouse, pen, voice input device, touch input device, etc. Output device(s) 508 such as a display, speakers, printer, etc. may also be included. All these devices are well known in the art and need not be discussed at length.

Those skilled in the art will realize that storage devices utilized to store program instructions can be distributed across a network. For example, a remote computer may store an example of the process described as software. A local or terminal computer may access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a DSP, programmable logic array, or the like.

1. A method of performing rewind playback, comprising:
sending to a media device a rewind playback command from a host device, the rewind playback command being indicative of a request to playback media stored in a recording medium in reverse order;
receiving a list of rewind playback speeds from the media device;
selecting a rewind playback speed;
sending the selected playback rewind speed from the host device to the media device, the playback rewind speed being a selection of speed from the list of rewind playback speeds;
receiving a first data block from the media device, the first data block being at a first data block starting address in the recording medium; and
receiving a second data block from the media device, the second data block starting address being less than the first data block starting address of the first data block.

2. The method of claim 1, further comprising:
playing back the first data block and the second data block.

3. The method of claim 1, further comprising:
receiving a third data block from the media device, the third data block being previously cached in memory by the media device.

4. The method of claim 1, further comprising:
determining a size of the first data block and communicating the size of the first data block to the host device.

5. The method of claim 1, further comprising:
negotiating a size of the first data block with the host device so as to optimize transfer speed or reliability.

6. The method of claim 1, wherein selecting the rewind playback speed is performed according to a user input.

7. The method of claim 1, wherein selecting the rewind playback speed is performed according to the size of the data.

8. A method of performing rewind playback by a media device, comprising:
receiving at a media device a rewind playback command from a host device, the playback command being indicative of a request to playback media stored in a recording medium in reverse order;
reading a first data block from the recording medium, the first data block being at a first data block starting address in the recording medium;
sending the first data block to the host device;
jumping to a location in the recording medium having a location address that is less than a second data block starting address of a second data block, the second data block starting address being less than the first data block starting address of the first data block;
reading additional data from the recording medium, the additional data being read starting at the location address to the second data block starting address;
reading the second data block from the recording medium; and
sending the second data block to the host device.

9. The method of claim 8, further comprising:
storing the additional data read from the recording in temporary memory.

10. The method of claim 9, further comprising:
upon receiving a subsequent read command to read at least a portion of the additional data, sending the temporary data to the host device.

11. The method of claim 8, further comprising:
sending a list of rewind playback speeds to the host device;
receiving a playback rewind speed from the host device, the playback rewind speed being a selection of speed from the list of rewind playback speeds.

12. The method of claim 8, further comprising:
determining a size of the first data block and communicating the size of the first data block to the host device.

13. The method of claim 8, further comprising:
negotiating a size of the first data block with the host device.

14. A method of performing rewind playback by a media device, comprising:
receiving at a media device a rewind playback command from a host device, the playback command being indicative of a request to playback media stored in a recording medium in reverse order;
reading a first data block from the recording medium, the first data block being at a first data block starting address in the recording medium;
sending the first data block to the host device;
jumping to a location in the recording medium having a location address that is less than a second data block starting address of a second data block, the second data block starting address being less than the first data block starting address of the first data block;
reading additional data from the recording medium, the additional data being read starting at the location address to the second data block starting address;
reading the second data block from the recording medium;
sending the second data block to the host device;
sending a list of rewind playback speeds to the host device; and
receiving a playback rewind speed from the host device, the playback rewind speed being a selection of speed from the list of rewind playback speeds.

15. The method of claim 14, further comprising:
storing the additional data read from the recording in temporary memory.

16. The method of claim 15, further comprising:
upon receiving a subsequent read command to read at least a portion of the additional data, sending the temporary data to the host device.

17. The method of claim 14, further comprising:
determining a size of the first data block and communicating the size of the first data block to the host device.

18. The method of claim 14, further comprising:
negotiating a size of the first data block with the host device.

19. A method of optimizing media operation, comprising:
sending to a media device an operation command from a host device, the operation command being indicative of an intent to perform an operation on the recording medium;
receiving a list of media device characteristics, the media device characteristics corresponding to media device resources such that the media device can optimize the operation command;
sending from the host device to the media device one or more selections of values of the media device characteristics in order to optimize the operation command; and
receiving a response from the media device of performance of the operation command.

20. The method of claim 19, wherein the characteristics include playback speeds, optimal size of input operation data, and alignment properties.
